(19) United States
(12) Patent Application Publication
(10) Pub. No.: US 2014/0358803 A1
(43) Pub. Date: Dec. 4, 2014

(54) REFERRAL MANAGEMENT SYSTEM

(71) Applicant: ATTORNEY SQUARE, LLC, Irvine, CA (US)

(72) Inventors: Roger Richard Carter, Newport Beach, CA (US); Scott Bradley Cooper, Irvine, CA (US); Marc Hannan Phelps, Corona Del Mar, CA (US); Nikolai Cornell, Santa Monica, CA (US); Eric Boisvert, Venice, CA (US); Mikael Santos, Whittier, CA (US)

(73) Assignee: ATTORNEY SQUARE, LLC, Irvine, CA (US)

(21) Appl. No.: 14/289,990

(22) Filed: May 29, 2014

Related U.S. Application Data
(60) Provisional application No. 61/829,165, filed on May 30, 2013.

(51) Int. Cl. G06Q 50/18; G06Q 10/10

(52) U.S. Cl. CPC G06Q 50/18; G06Q 10/10
USPC 705/311

(57) ABSTRACT

A referral management system can provide functionality of tracking referrals for professionals. The referral management system may, for instance, enable users to send and receive referrals. In certain embodiments, the referral management system may also enable users to track the status of sent and received cases. In other embodiments, the referral management system may enable users associated with the case to communicate with each other. The referral management system can also generate reports and derive data for suggestion to users.

### CROSS-REFERENCE TO RELATED APPLICATIONS

The present application claims the benefit of U.S. Provisional Patent Application No. 61/829,165, filed May 30, 2013 (entitled “REFERRAL MANAGEMENT SYSTEM”), the disclosure of which is hereby incorporated by reference in its entirety.

### BACKGROUND

Referrals are an important source of work for many professionals. In the legal field, some attorneys might get all of their work from referrals. Moreover, attorneys do not always have the necessary expertise to meet all of their client's needs. Finding a qualified attorney for referring a client can be challenging. Attorneys may also want to track the status of the referred cases and collect fees for sending referrals. The fee structure can vary between a flat fee, no fee, and a contingency fee structure. Attorneys may need to manage hundreds of referrals and their associated contacts. Thus, managing these referrals, especially tracking the status of cases and fees, can become time-consuming and cumbersome.

### SUMMARY

The systems and methods described herein can be implemented by a computer system comprising computer hardware. The computer system may include one or more physical computing devices, which may be geographically dispersed or co-located.

Certain aspects, advantages and novel features of the inventions are described herein. It is to be understood that not necessarily all such advantages may be achieved in accordance with any particular embodiment of the inventions disclosed herein. Thus, the inventions disclosed herein may be embodied or carried out in a manner that achieves or selects one advantage or group of advantages as taught herein without necessarily achieving other advantages as may be taught or suggested herein.

In certain embodiments, a system for tracking referrals can include one or more hardware processors configured to execute a plurality of software modules, the software modules including at least a case management module that can access case data relating to a first attorney, the case data corresponding to one or more cases associated with the first attorney. The case data can include an identifier, a fee value, a status, and one or more attorneys associated with the case. The system can also include a user interface module that can display a user interface including case data and one or more active links. The active links can be associated with a respective one of the one or more cases associated with the first attorney. The active links can enable the first attorney to communicate directly with the one or more attorneys associated with the case.

### BRIEF DESCRIPTION OF THE DRAWINGS

Embodiments disclosed herein are described below with reference to the drawings. Throughout the drawings, reference numbers are re-used to indicate correspondence between referenced elements. The drawings are provided to illustrate embodiments of the inventions described herein and not to limit the scope thereof.

FIG. 1 illustrates an embodiment of a computing environment including a referral management system that can enable users to effectively manage their sent and received referrals.

FIG. 2 illustrates an embodiment of a dashboard user interface for tracking referrals.

FIG. 3 illustrates an embodiment of a case summary toolbar for tracking referral fees.

FIG. 4 illustrates an embodiment of a case portal user interface to access case details.

FIGS. 5A through C illustrate an embodiment of a send/add case user interface to add a new case from another user or refer a case to another user of the referral management system.

FIG. 6 illustrates an embodiment of a received case management user interface for managing received cases.

FIG. 7 illustrates an embodiment of a sent case management user interface for managing sent cases.

FIG. 8 illustrates an embodiment of a new connection user interface for adding new connections.

FIG. 9 illustrates an embodiment of a connection management user interface for managing connections.

FIGS. 10A through C illustrate embodiments of user interfaces for signing up, registration, and logging in to the referral management system.

FIG. 11 illustrates an embodiment of a user interface for new members to enter their professional and contact information.

FIG. 12 illustrates an embodiment of a referral management process.

FIG. 13 illustrates an embodiment of a notification received from the referral management system.

### DETAILED DESCRIPTION OF SPECIFIC EMBODIMENTS

### I. Introduction

Many professionals rely on incoming referrals for their source of work. Sometimes professionals also need to create outgoing referrals based on their client or customer's needs. Thus, managing the multitude of incoming and outgoing referrals can be both time consuming and challenging.

This disclosure describes embodiments of a referral management system that can provide professionals a system for managing their incoming and outgoing referrals. The referral management system can also assist professionals to directly communicate with the one or more other professionals associated with the case through active links. In one embodiment, the referral management system can be used by attorneys for sending and receiving cases. Attorneys can track and communicate with other attorneys on the cases. For example, a referring attorney can request an update on a case, which can automatically be communicated to the referred-to attorney. The referred-to attorney can update the status of case that can automatically be communicated to the referring attorney by the referral management system.

The features of the systems and methods described herein can also be implemented for referral management between other professionals. The systems and methods can also be implemented to track referrals between interdisciplinary professionals. For example, a general practitioner involved in a workplace injury can refer her client to an optometrist, a lawyer, or an insurance agent.

### II. Example Referral Management System

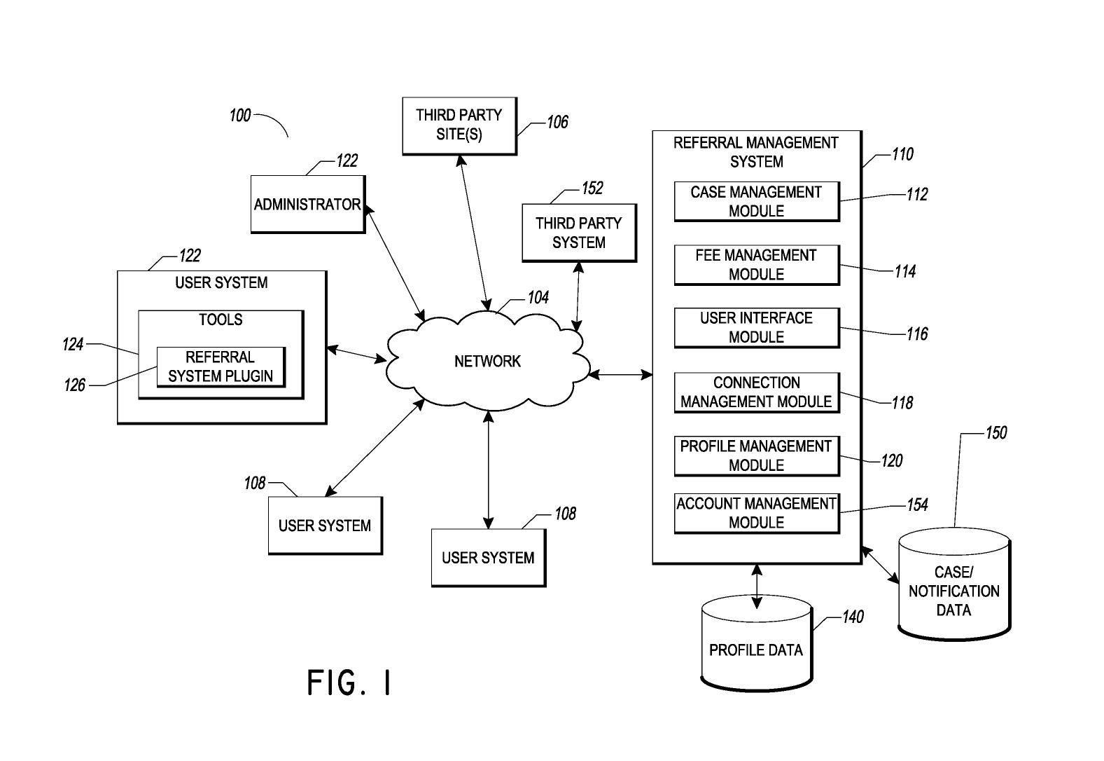

FIG. 1 illustrates an embodiment of a computing environment 100 for providing users with access to a referral management system 110 that can assist users with managing referrals. In one embodiment, the referral management system 110 can be used by attorneys to manage referrals. Attorneys can use the system, for example, to send and receive referrals, track the status of the referrals, communicate directly with the attorneys handling the referrals, receive notifications about the case, manage the fees, and perform other tasks relating to managing referrals. In the computing environment 100, user systems 108 can access a referral management system 110, which may include one or modules to enable users to manage their referrals.

The profile management module 120 can enable a new user to register with the referral managing system and can also assist the new user and existing users to manage their profiles. A user profile may include personal and professional information of the user. In some embodiments, the profile management module 120 can get information of the user from a third party website. For example, the profile management module 120 may extract information (through parsing, scraping, or API access, for example) from social or professional websites, such as, LinkedIn, or Google+, or a law firm profile webpage. Example user information can include name, title, organization, location, primary area of practice, secondary area of practice, experience, a LinkedIn url, a law firm personal profile page URL, and contact information. A user may input such information through one or more user interfaces generated by user interface module 116 described in more detail below. The profile information may be stored in a profile data repository 140. More generally, the profile data repository 140 can include a database, for instance, that maps user profile information with their connections and associated cases.

The connection management module 116 can enable users to add connections to other users of the referral management system 110. The connection management module 116 can also assist users in inviting other professionals to join the referral management system 110. In some embodiments, the connection management module 116 can organize a user's connections by area of law. The connection management module can also track received and pending connection requests. In some embodiments, a request for connection can be sent along with a case referral as described in detail below. In yet another embodiment, the referral management system 110 can automatically send connection requests to contacts stored in one or more of the user's accounts. For example, accounts may include email accounts, outlook contacts, phone contacts, or the like.

The user interface module 116 can interact one or more other modules of the referral management system 110 to generate user interfaces. In some embodiments, the user interfaces can be one or more web pages/electronic communications. The user interface module 116 can also receive data from the user systems 108. The data can be stored by one or more data repositories 140 and 150 of the referral management system 110 and then output to one or more user interfaces by the user interface module 116. Embodiments of user interfaces are described in detail below.

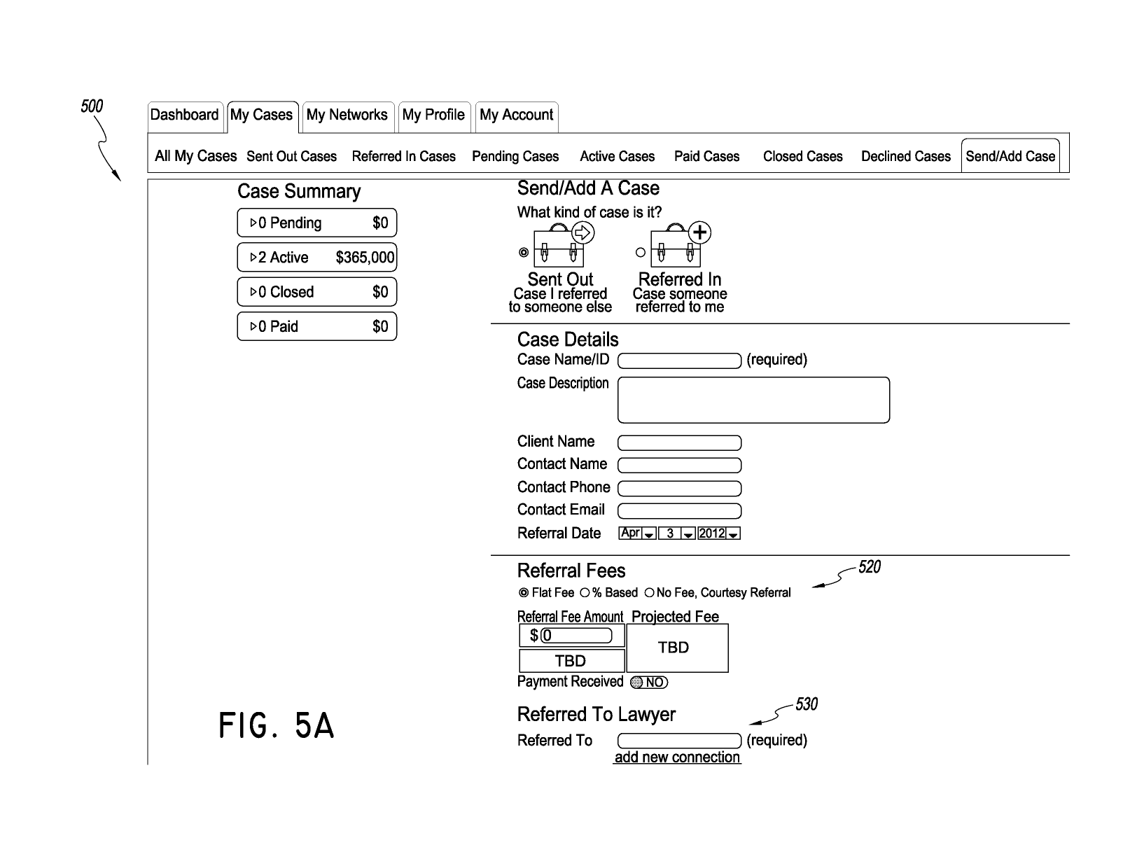

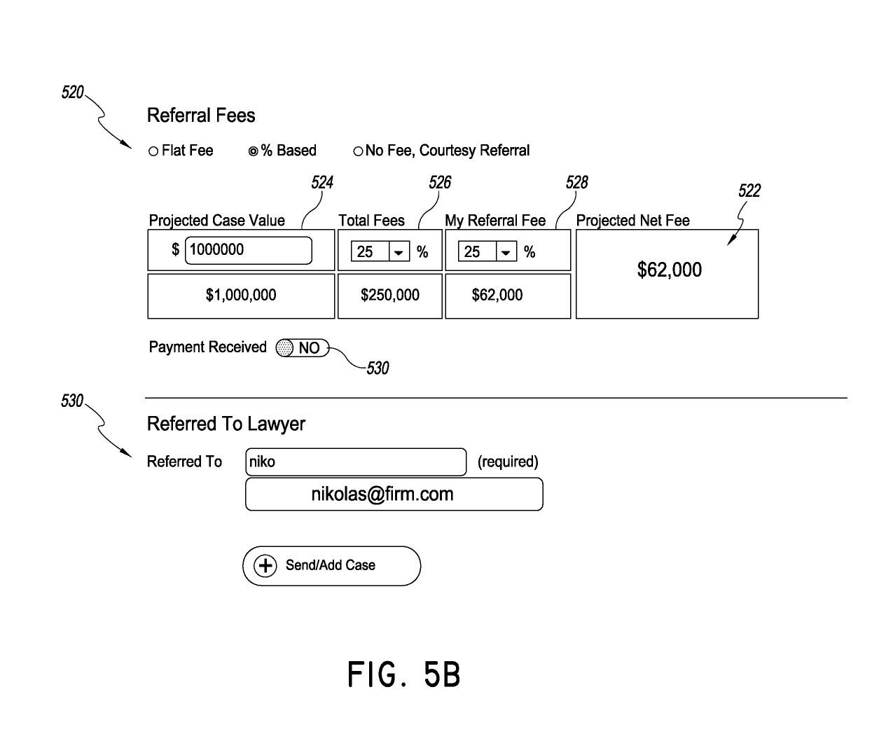

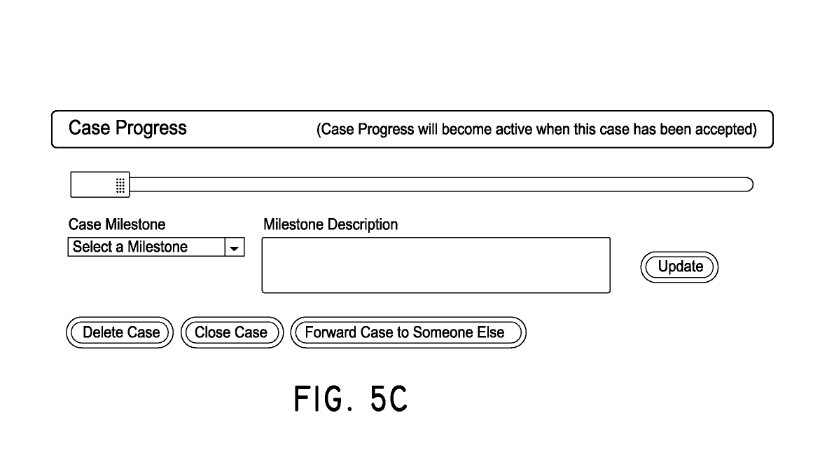

The case management module 112 can enable users to send and receive cases. Users can send and receive cases to/from any of the other users using the referral management system 110. The case management module 112 can also track and maintain the cases. For example, the case management module 112 can associate a case with one or more attorneys. A case can have one or more originating attorneys or entities. Users can add new cases through one or more user interfaces generated by the user interface module 116 as described more in detail below with respect to FIGS. 4 and 5.

The fee management module 114 can track and maintain referral fee information for a particular case. The referral fee structure can vary based on cases or user preferences. For example, a referral fee can be based on a flat fee structure or a percentage based structure. In some embodiments, referral fees may be tied to progress of the case. In some instances, where referral fees are dependent on the outcome of cases, the fee management module 114 can calculate a projected fee from the referral. The fee management module 114 can also track portions of the fees paid or received from referrals. The fee management module 114 can also enable transfer of referral fee electronically. For example, referral fees may be made via credit card, debit card, PayPal, or through bank routing. A third party system 152 may be integrated with the referral management system 110 for handling billing. Some referral cases may be courtesy referrals without any fees associated with them.

The account management module 154 alone or in combination with one of the other modules of the referral management system 110 can enable users to maintain and update information corresponding to their accounts. The account management module 154 can enable users to change their password to access the referral management system 110 or update their billing information. Users can enter their credit card or bank account information. Users can also choose their account type from one of the many categories available. In one embodiment, the categories of accounts may include trial, regular, and premium. In some embodiments, the referral management system 110 can limit or expand the available features to the users depending on their account type. For instance, users with access to premium membership may select the option to have their name listed in a general directory. The general directory can be accessible to all members of the referral management system 110. Accordingly, users may refer cases to any of the members listed in the general directory of the referral management system 110.

In some embodiments, the administrator system 122 can manage internal workings of the referral management system 110. For example, administrators system 122 can enable administrators to add or remove users from the referral management system 110. Administrators may also be able to add or remove cases from the referral management system 110 and create reports that include data corresponding to the referral management system 110. The data may include member or case statistics, for example, personal information (name, email, or like), case information (number of incoming/outgoing cases, projected net fee, or like). Data may be aggregated for each user or for all users of the referral management system 110.

The referral management system 110 can be implemented in computer hardware and/or software. The referral management system 110 can execute on one or more computing devices, such as one or more physical server computers. In implementations where the referral management system 110 is implemented on multiple servers, these servers can be co-located or can be geographically separate (such as in separate data centers). In addition, the referral management system 110 can be implemented in one or more virtual machines that execute on a physical server or group of servers. Further, the referral management system 110 can be hosted in a cloud computing environment, such as in the Amazon Web Services (AWS) Elastic Compute Cloud (EC2) or the Microsoft® Windows® Azure Platform.

The user systems 108 can remotely access the referral management system 110 on these servers through the network 104. The user systems 108 can include thick or thin client software that can access the referral management system 110 on the one or more servers through the network 104. The network may be a local area network (LAN), a wide area network (WAN), such as the Internet, combinations of the same, or the like. For example, the network 104 can include an organization's private intranet, the public Internet, or a combination of the same. In some embodiments, the user software on the user system 108 can be a browser software or other application software. The user system 108 can access the referral management system 110 through the browser software. In certain embodiments, some of the referral management system 110's functionality can be implemented on the user systems 108.

The referral manager system 110 can be integrated with the third party tools through a plug-in or an API (application programming interface). In some embodiments, third party tools may come pre-installed with a plug-in to the referral management system 110. In other embodiments, a plugin to the referral management system 110 may be installed on to a third party tool. For example, a third party tool can include Microsoft Outlook.

In general, the user systems 108 can include any type of computing device capable of executing one or more applications and/or accessing network resources. For example, the user systems 108 can be desktops, laptops, netbooks, tablet computers, smartphones, PDAs (personal digital assistants), servers, e-book readers, video game platforms, television set-top boxes (or simply a television with computing capability), a kiosk, combinations of the same, or the like. The user systems 108 include software and/or hardware for accessing the referral management system 110, such as a browser or other client software.

### III. Dashboard

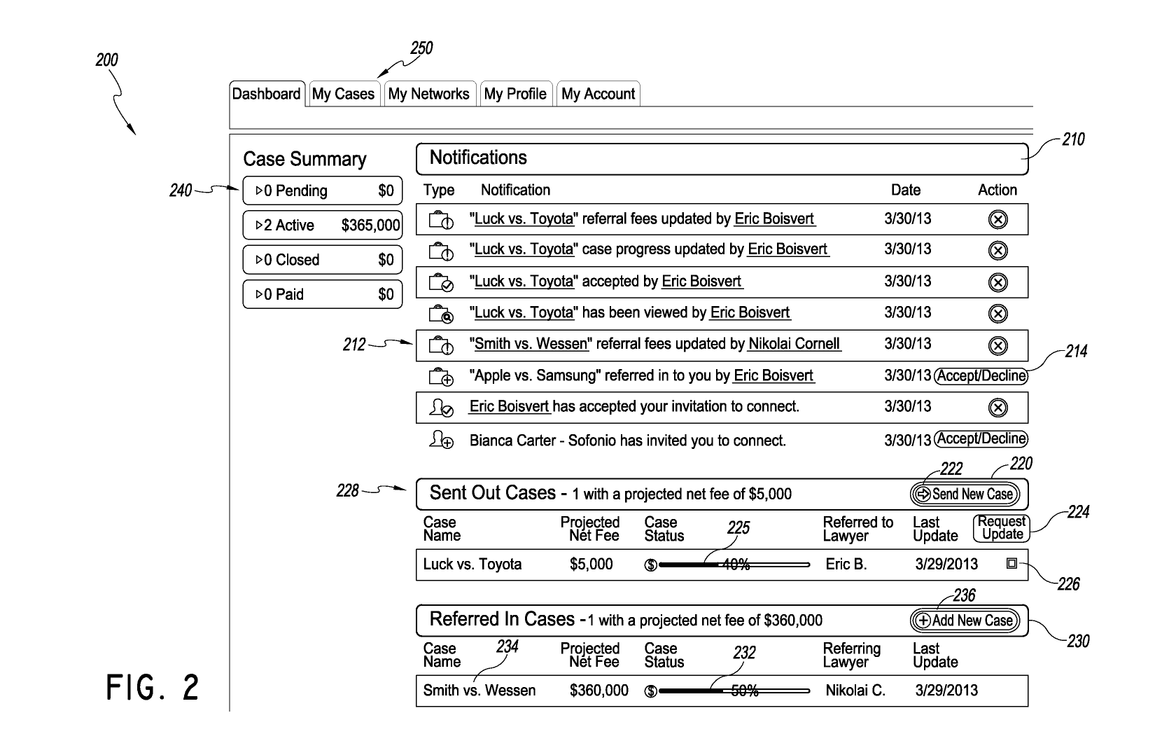

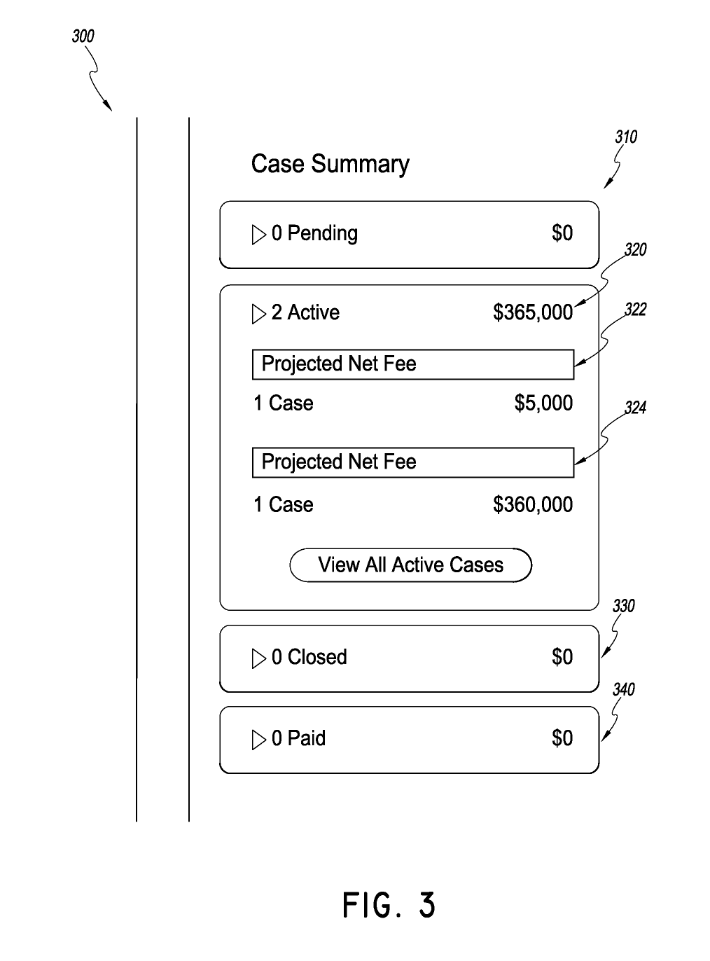

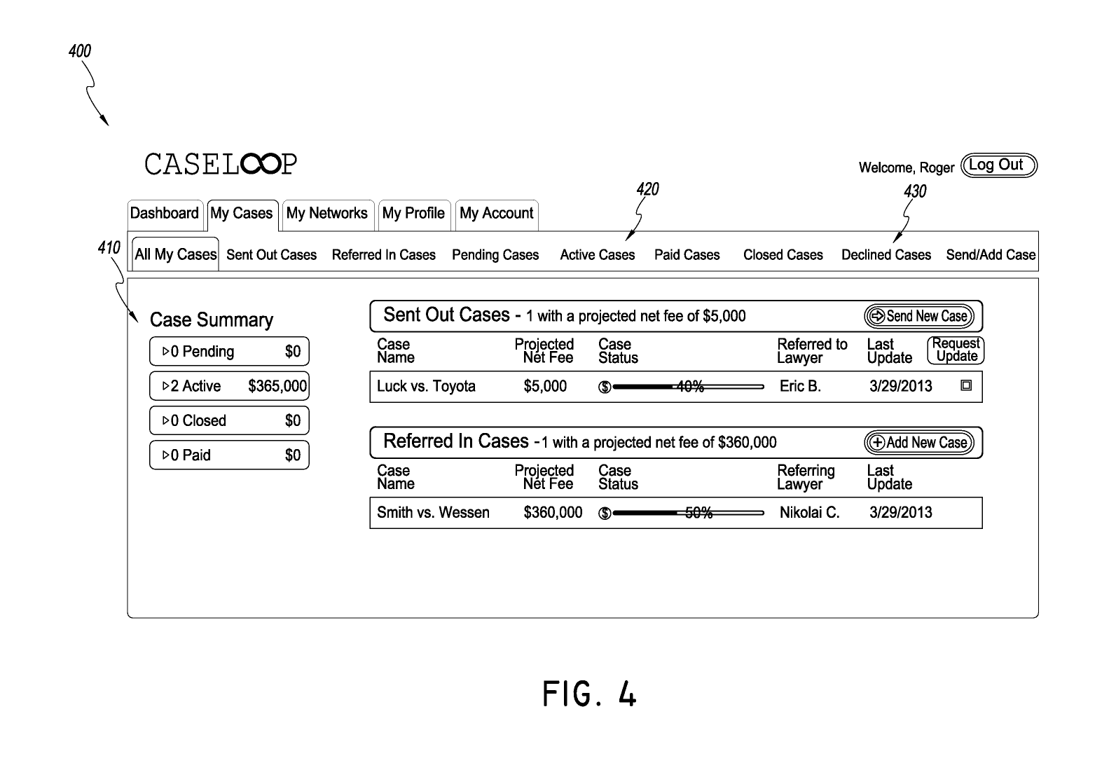

FIG. 2 illustrates an embodiment of a dashboard interface 200 generated by the user interface module 116. The dashboard interface 200 can include a notifications tool 210, sent referrals tool 220, and received referrals tool 230. In some embodiments, the dashboard interface 200 may also include a case summary toolbar 240, as described more in detail with respect to FIG. 3, and a menu toolbar 250. In some embodiments, the notifications tool 210, sent referrals tool 220, and received referrals tool 230 are all displayed in a web page or other electronic communication. In other embodiments, the tools can be displayed in multiple web pages and/or other electronic communications.

The notifications tool 210 can include updates associated with a particular user. For example, notification items 212 can include information relating to type, description, date, and one or more active links 214. The active links 214 can enable a user to take action relating to a notification. In one embodiment, the active links enable users to directly communicate with the one or more users associated with a notification. In the illustrated example, a user may accept or decline a referral by clicking on (or otherwise selecting) the active link 214. In some embodiments, clicking on the active link may direct to another web page and/or electronic communication. For example, if the user clicks on the active link 214, the referral management system 110 through one of its modules may direct the user to another web page and/or electronic communication that may have more information on the referred case. In further embodiments, the user may accept or decline a case or connection through an active link 214 without leaving the dashboard interface. The referral management system 110 can receive a user's input (for example, a request to accept or decline a case) and store the information in its data repositories.

The referral management system 110 can also output the user's selection to one or more other users associated with the case. In the illustrated example, when the referred-to attorney accepts or declines a case, the referral management system 110 can notify the referring attorney of the referred-to attorney's selection. The referral management system 110 can also automatically notify the referring attorney when the referred-to attorney has viewed the referral. The notifications tool 210 can further include updates relating to the cases and connections associated with the user. In some embodiments, the referral management system 110 can notify users when progress or referral fees associated with a case are updated. Other updates can include status of connection invitations. Users can also accept or decline an invitation to connect with other members of the referral management system 110. In some embodiments, users can accept or decline an invitation to connect by selecting an active link in the notifications tool 210. The user's selection can automatically be communicated to the invitee. Accordingly, the referral management system 110 can enable users to directly communicate with each other.

In some embodiments, the dashboard interface 200 can provide users with all the updates relating to their cases and connections on a single user interface page or screen. The dashboard interface 200 can include the sent referrals tool 220 and the received referrals tool 230. In the illustrated example, the sent referrals tool 220 can enable the referring user to track cases that were referred out to one or more referred to users. In some embodiments, the sent referrals tool 220 can include a list of all sent out cases. As shown in FIG. 2, each listing of a case 228 may include a case identifier, projected net fee, case status 225, one or more referred-to users, date of last update, and any other information that might be relevant. The sent out referral tools may also include active links 222, 224, and 226 to enable a user to communicate with or more other users of the referral management system 110. For example, the referring attorney can send new cases to one or more other attorneys of the referral management system 110 by selecting the active link 222. Users can also request updates on their cases from referred-to lawyers. In the illustrated example shown in FIG. 2, users can select one or more active links 226 to identify cases for update and then click on active link 224 to request updates from the one or more referred-to lawyers associated with the cases. In other embodiments, requests for updates may be sent by the referral management system 110 on a case by case basis based on selections of active links 226. On receiving a request for update, the referral management system 110 can notify the one or more referred-to lawyers associated with the case, enabling the referring attorney to directly communicate with the referred-to attorneys associated with the case. In some embodiments, the referral management system 110 can enable users to call, send an email, send a text message, and/or communicate via other electronic means to other users associated with the case by selecting the active links.

In some embodiments, the referral management system 110 can automatically remind the user that her referral is pending after a certain period of time has elapsed. The period can be predefined in the referral management system 110 or can be configured by the users. In one embodiment, the predefined period can be five days. The notification can also include an active link for directing the user to an interface showing more case details as described with respect to embodiments illustrated in FIGS. 5A-C. The notification may also include an active link to forward the case to another attorney. In one embodiment, the active link for forwarding the case to another attorney can be part of the case details user interface as illustrated in FIG. 5C.

As described above with respect to the sent referrals tool 220, the received referrals tool 230 can also enable the user to communicate directly with the referring attorney regarding the case. In one embodiment, the user can change the status of the case directly from the dashboard interface 200 by selecting an active link 232. The active link 232 may be a movable status bar (not shown). In yet more embodiments, the user can select an active link 234 associated with the case to communicate updates relating to the case as described more in detail with respect to FIG. 4.

The user interfaces may be generated by the referral management system 110, the referral system plugin 126, or a combination of both. For illustration purposes, these user interfaces are shown primarily in web browsers, although it should be understood that these user interfaces can be generated with applications other than web browsers (including mobile applications). Further, example user interface controls (active links) are shown, including buttons, status bars, hyperlinks or links, and the like. Any of the user interface controls shown can be replaced with other user interface controls, including but not limited to radio buttons, check boxes, text boxes, select boxes or drop-down boxes, combinations of the same, and the like.

### IV. Case Summary Toolbar

FIG. 3 illustrates an embodiment of a case summary toolbar 300 that can assist users in tracking and maintaining their cases. The user interface module 116 can generate the case summary toolbar 300 using information stored in the case/notification data repository 150. The case summary toolbar 300 can be included in any of the user interfaces generated by the user interface module 116. In one embodiment, the case summary toolbar 300 can include a list of active cases 320. The list of active cases 320 can further include a sum of projected net fee for sent out cases and also a sum of projected net fee for referred in cases 324. The case summary toolbar 300 can also include a list of pending cases 310, a list of closed cases 330, and a list of paid cases 340. The lists 310, 320, 330, and 340 may be arranged in any order. In some embodiments, only some of the lists 310, 320, 330, and 340 may be included in the case summary toolbar 300. The case summary toolbar 300 can also be configurable by the user. For example, a user can select preferences to display only the active cases in the case summary toolbar 300. The user interface module 116 can add the projected fees for cases in each of the categories 310, 320, 330, and 340 and display the sum as shown in FIG. 3. The lists can also expand to reveal more information in each category. In some embodiments, the expanded list can include a case identifier along with its projected net fee.

### V. Example Case Referral—Sending/Receiving Process

FIG. 4 illustrates an embodiment of a case portal interface 400 that can also include the case summary toolbar 410 and a case menu toolbar 420. The case portal interface 400 can include a list of sent and received cases and enable users to send or add new cases. In one embodiment, the referral management system 110 can track declined cases 430. Users can also sort the list of cases by any of the categories illustrated in FIG. 4. For example, the referral management system 110 can sort the cases according to the Projected Net Fee based on a user input selecting the Projected Net Fee column header.

FIG. 5A illustrates an embodiment of a send/add case interface 500 that can enable users to send referrals or add referred-in cases to their docket. In the depicted embodiment, users can enter case identifier, description, client name, contact information, referral fees and other case related information. The referral fee menu 520 can enable the users to select the type of referral fee structure. As illustrated in FIG. 5B, the referral management system 110 can enable users to select a fee structure. In one embodiment, users can select a flat or percentage based fee structure. The referral management system 110 can automatically calculate a projected net fee 522 in response to input from a user for projected case value 524, total fees 526, and user's referral fees 528. In the illustrated example, the projected net fee is 25% of the total fees, which is 25% of the projected case value. In some embodiments, the user interface 500 may also include a selectable indicator 530 corresponding to whether payment was received for the referral. The indicator 530 can enable users to track statuses of payments for the referrals. In one embodiment, the users can select one or more attorneys for referral through a referral input 530 by entering their corresponding identifiers (for example, email addresses). The referral management system 110 can suggest connections while the user is entering information as illustrated in FIG. 5B. Users can look up connections based on name, email, or other connection identifiers.

FIG. 5C illustrates an embodiment of a received case user interface. The user can select active links corresponding to rejecting the referral or forwarding the referral to someone else.

### VI. Example Referral Case Tracker

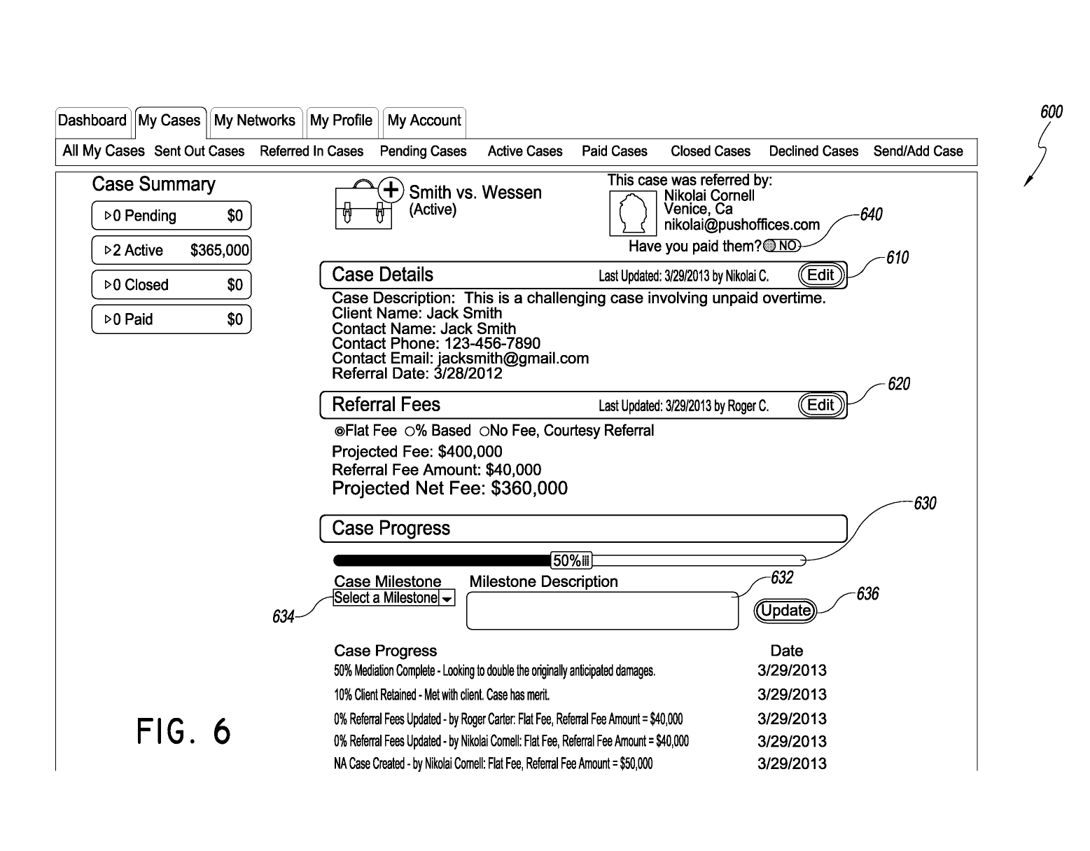

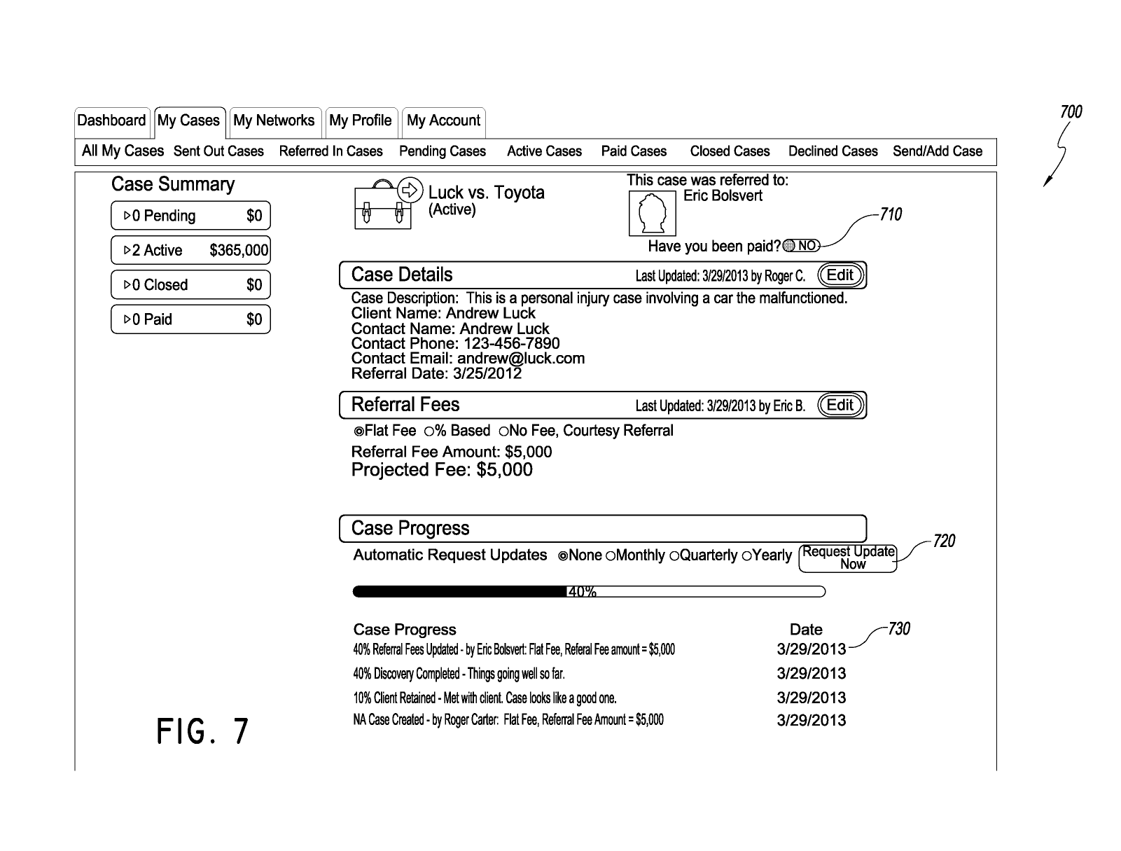

FIGS. 6 and 7 illustrate embodiments of case manager interfaces 600 and 700 for a referred in case and a referred out case, respectively. The user interface module 116 can generate the user interfaces based on data stored in data repositories 140 and 150, alone or in combination. The user interface module 116 can also import data from third party sites 106 to generate the user interfaces 600 and 700. In one embodiment, the user interface module 116 can import data relating to a case directly from court reporting websites, such as justia.com or PACER. The imported data may also be used to update case progress. Users can also select an active link (not shown) to turn the notifications on or off for a particular case.

In some embodiments, the referred in case manager interface 600 can include a case progress indicator 630. The case progress indicator 630 can be an active link for enabling a user to communicate the status of the case to one or more other attorneys. In the illustrated example, the case progress indicator 630 includes a selectable status bar. Users may move the status bar to a particular percentage value corresponding to the status of the case. Users may also select a milestone 634 and include a brief description 634 corresponding to the update. In one embodiment, users can select the update to be private and not viewable by the other attorneys associated with the case. In some other embodiments, users can select the update link 636 to communicate the updated status of the case to all the attorneys associated with the case. The referral management system 110 can display the updated status of the case in the dashboard as described above with respect to FIG. 2. The referral management system 110 can also communicate the updated status via an email, a text message, or other electronic communications. The referral management system 110 can further update the status in the case data repository 150. The users associated with the case can also view the updated status in their corresponding case manager interfaces as illustrated in FIGS. 4 and 7. The referred-in case manager interface 600 can also include an active link 640 for managing the payment status of the case.

FIG. 7 illustrates a referred-out case manager interface 700 that can assist users in managing referrals sent out to one or more referred to attorneys. In one embodiment, users can select the active link 720 to communicate with one or more other attorneys associated with the case. For instance, users can select the active link 720 to request updates on the status of the case. The referral management system 110 can communicate the request for update to one or more other attorneys associated with the case through the dashboard interface as described in FIG. 2, the case manager interface as described in FIG. 6, or via other modes of electronic communications (for example, SMS, e-mails, or the like). In some embodiments, the users can select an option to automatically receive updates.

### VII. Managing Connections

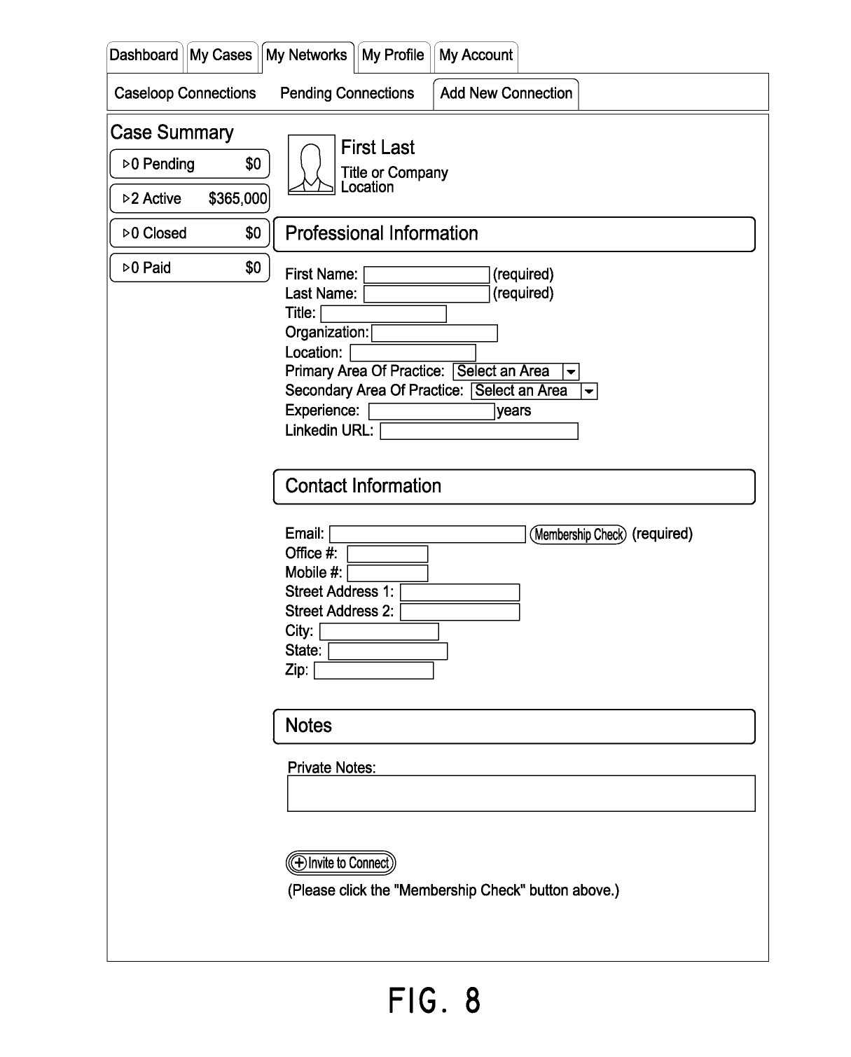

FIG. 8 illustrates an embodiment of a new connection user interface 800 for adding a new connection. The user interface 800 can be generated by the user interface module 116. The user interface 800 can enable users to enter and potentially add a new connection to their network. In one embodiment, the connection refers to another attorney that may already be a member of the referral management system 110. The referral management system 110 can verify if the connection is a member of the system. For example, the referral management system 110 can look up the email address of the connection entered by the user to check if it exists in the profile data repository 140. If the email address is not found in the system, the referral management system 110 can send an invitation to the connection at that email address to join the referral management system 110. In some embodiments, connections can refer to professional not in the same discipline, for example, a doctor can add a lawyer as a connection for referring a case. There may ethical considerations when cases are referred between professionals not in the same discipline. The referral management system 110 can warn users of ethical issues while referring a case. For example, the referral management system 110 can prohibit fee collection for certain referrals to comply with ethical rules.

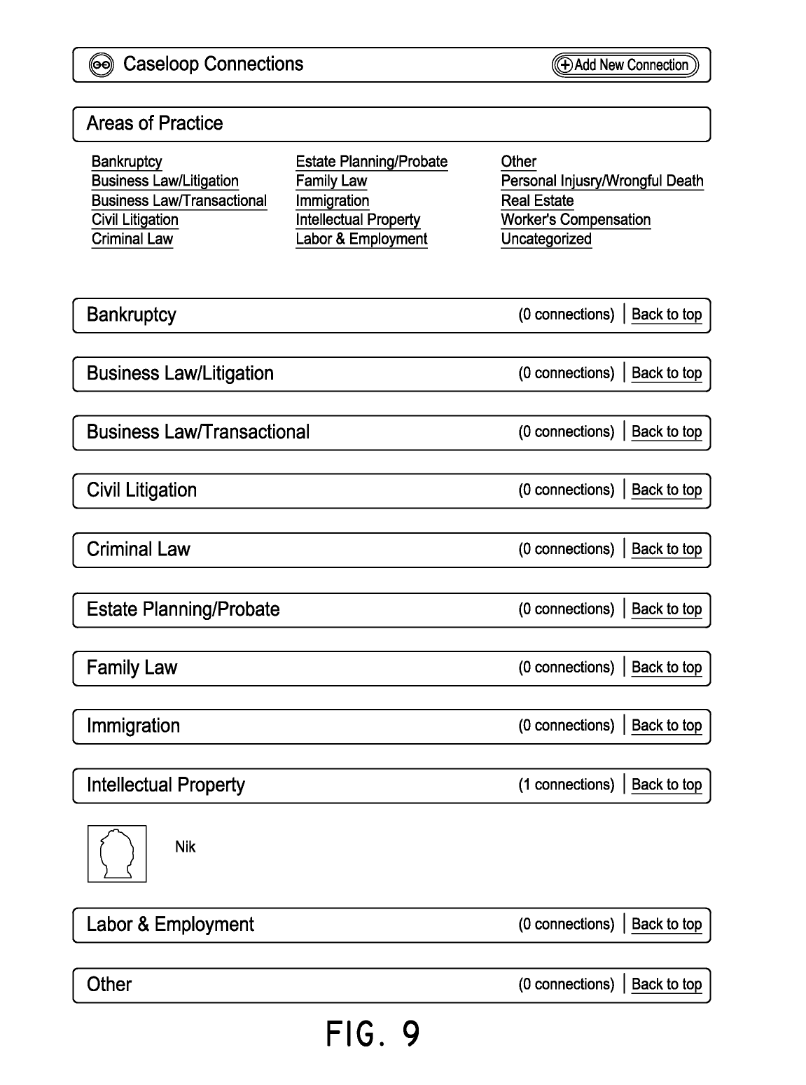

FIG. 9 illustrates a connection manager interface 900 that can enable users to manage their connections. In one embodiment, the referral management system 110 can sort the connections by practice area. Connections may also be sorted alphabetically. In another embodiment, users can rate their connections. For instance, users can rate and/or endorse their connections based on successful referrals. The referral management system 110 can also sort the connections based on ratings or endorsements. In some embodiments, the referral management system 110 can sort based on user's own rating or endorsement. The referral management system 110 can sort the connection based on overall ratings received by that connection. The referral management system can also enable users to delete connections.

The referral management system 110 can also include a search functionality that can enable users to search referral candidates. For example, search functionality can be implemented to enable users to search by one or more of the following criteria: area of practice, locations, ratings, endorsements, referral fee percentage, and preference. Other criteria may also be used.

### VIII. Registering with the Referral Management System

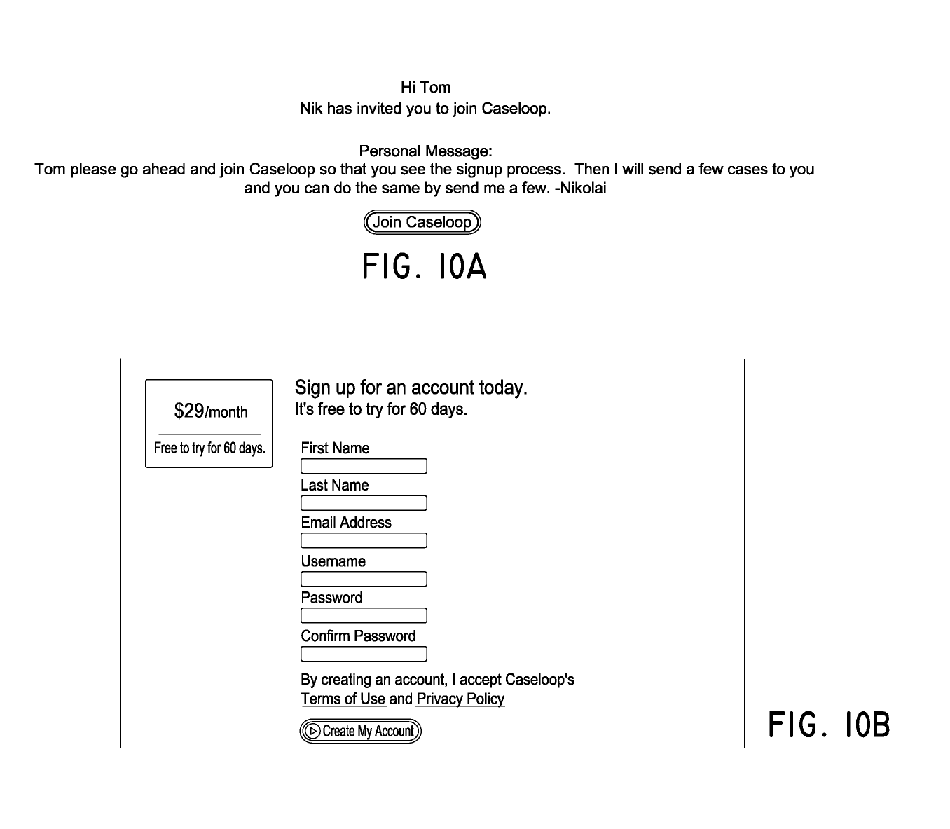

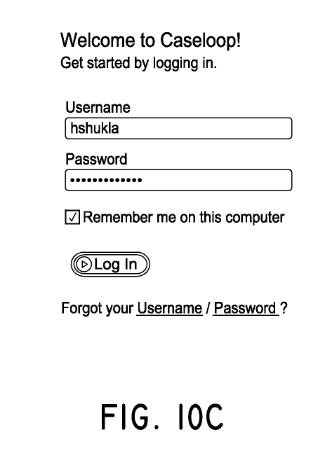

FIG. 10A illustrates an invitation notification that can enable new users to register with the referral management system 110. The new user can select link 1010 to sign up with the referral management system 110. An example sign up interface is illustrated in FIG. 10B.

FIG. 10C illustrates an embodiment of a user interface enabling users to log in to the referral management system 110. The referral management system 110 can be password protected. In one embodiment, users can select their username and password.

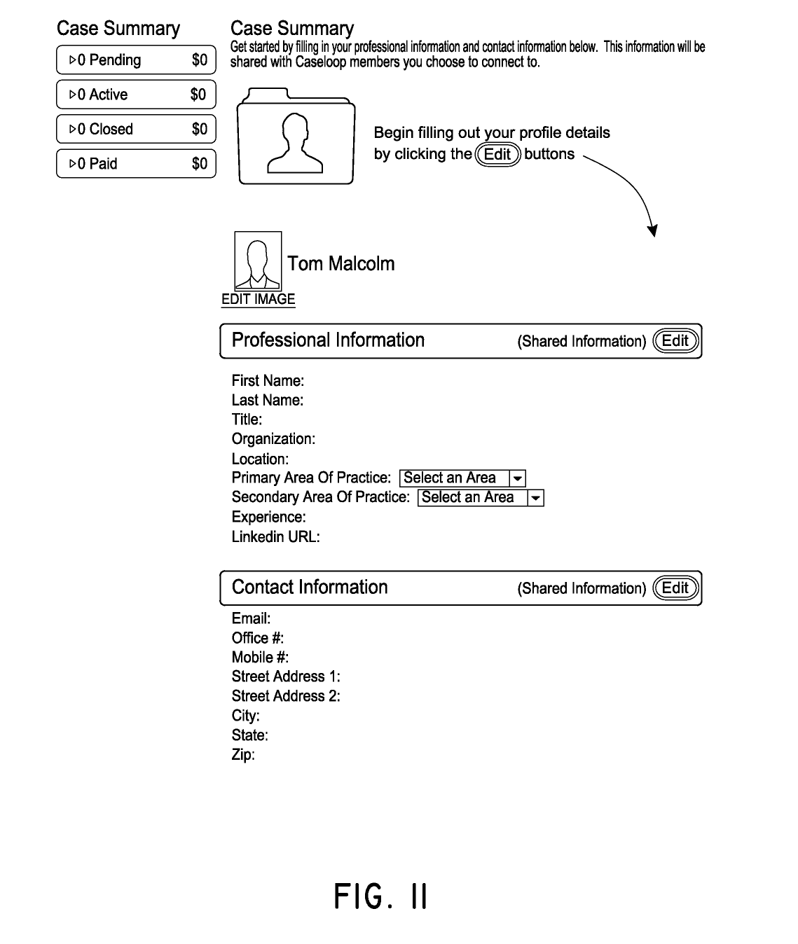

FIG. 11 illustrates an embodiment of a user interface for enabling users to enter their professional and contact information.

### IX. Reports

The referral management system 110 can also generate custom reports based on user-entered queries or parameters. For example, users can query to list all of the cases referred to a particular attorney that have not been paid yet. Reports may also be generated to derive statistical data based on data stored in the referral management system. For example, a report may be generated to identify for example how long the average single plaintiff employment case takes to resolve. Other examples of reports include calculating average settlement/resolution value for a particular type of case. In some embodiments, the projected net fee described above can automatically be calculated based on the derived statistical data. The reports can be further refined to include more specific set for criteria. In one embodiment, a report can also be generated to derive how quickly and for how much does the average second year attorney settle a particular type of case. The reports may be displayed in graphical chart format. The parameters, including attorney experience and type of case, can be varied. In some embodiments, the referral management system may also be able to track and derive at what point in the life cycle cases typically resolve more favorably for the plaintiff or defendant. The referral management system 110 can use the derived data to intelligently assist the users in managing their cases. In one embodiment, the referral management system can notify a user that it might be a good time to settle based on historical data. Moreover, the referral management system can use derived data to suggest attorneys for referring the case. The suggestion may be based on, for example, an attorney's years of practice, referral income, average time of resolution, or other relevant parameters. The referral management system can run the report based on information stored in the data repositories 140 and 150 and generate an output data based on the input query parameters. The output data can be displayed on a user interface or downloaded as a PDF, excel file, or the like.

### X. Caseboard

In some embodiments, the referral management system 110 can generate a caseboard interface that can enable users to view cases posted by users of the referral management system. In some embodiments, only the unassigned cases are listed in the caseboard interface. The caseboard interface can include one or more active links such that the users of the referral management system can communicate with the attorneys associated with the cases listed on the caseboard. In another embodiment, the referral management system 110 may recommend one or more cases available on the caseboard to the users of the referral management system 110. The referral management system 110 can also create a general directory and display the directory through the user interface module 116. The directory may include list of available attorneys organized by one or more categories (for example, specialty, location, referral fee %, success rate, etc.) As described above, the referral management system 110 may only include users with premium membership in the general directory.

### XI. Example Communication Process

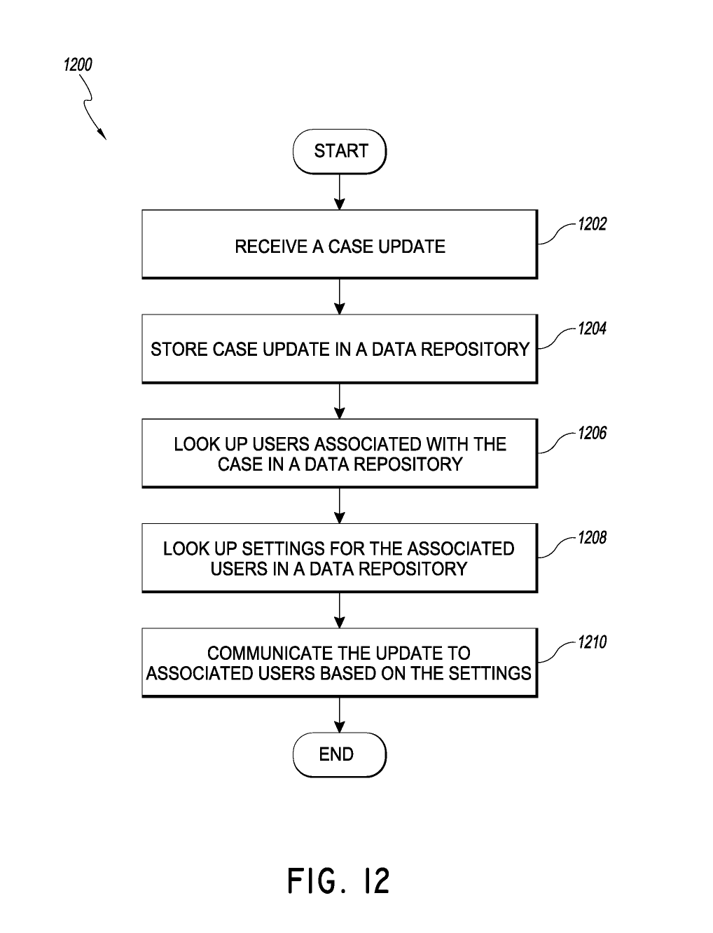

FIG. 12 illustrates an embodiment of a referrals tracking process 200 for tracking referrals and communicating between users associated with the referral. The referrals tracking process can be implemented by any of the systems described above. For illustrative purposes, the process 200 will be described as being implemented by components of the computing environment 100 of FIG. 1. The process 200 depicts an example overview of tracking referrals. The process can be performed in response to a request from a user for an update, for example, by the user selecting an active link. In another embodiment, the process 200 can be performed without user request, providing relevant case status information to a user at any time during the lifecycle of the case.

The process 200 begins at block 1202, where the referral management system receives a case update. In some embodiments, the case update might be from a first user of the referral management system 110. In another embodiment, the case update might be received from an external third party website or API. The first user can be, for example, a referred-to attorney associated with the case. The referred-to attorney can add notes on the case or change the case progress. In some embodiments, the referral management system 110 can store the case update in a data repository at block 1204. The referral management system 110 can look up all the users associated with the case and their notification settings. The referral management system 110 can communicate the update to a second user associated with the case as identified by the referral management system at block 1206. In some embodiments, the referral management system 110 can communicate the update to the second user automatically in response to receiving the case update from the first user. The referral management system 110 can communicate the update using any of the user interfaces described above.

### XII. Additional Embodiments

It should be noted that in addition to attorney referrals, any of the features described herein can also be implemented for other referral systems. For example, the referral management system 116 can be used by commercial and residential realtors to track and manage referrals. As an example, a realtor may have a client interested in purchasing a home in a geographical area outside of his or her working area. This may be common when the client is moving out of the city. Currently, realtors do not have a centralized system to refer clients and track the referrals. The referral management system 116 can help referring realtors find listing realtors for their clients. The referral management system 116 can assist realtors in finding the listing realtors based on their expertise, geographical locations, reviews, etc. As described above with respect to lawyers, the referring realtors can send requests to the listing realtors based on their clients' needs. As an example, consider a client moving from LA to New York City. The referring realtor may be assisting the client in selling the client's home in LA. The client may ask the referring realtor for assistance purchasing or leasing a home in New York. The referring realtor can use the referral management system 116 to seek listing realtors in New York. Once the client is referred, the referral management system 116 can also be useful in tracking the progress and managing referral fees as discussed above with respect to legal cases. Accordingly, in some embodiments, the referral tracking system 116 can advantageously help realtors in growing and maintaining their portfolios nationally or internationally.

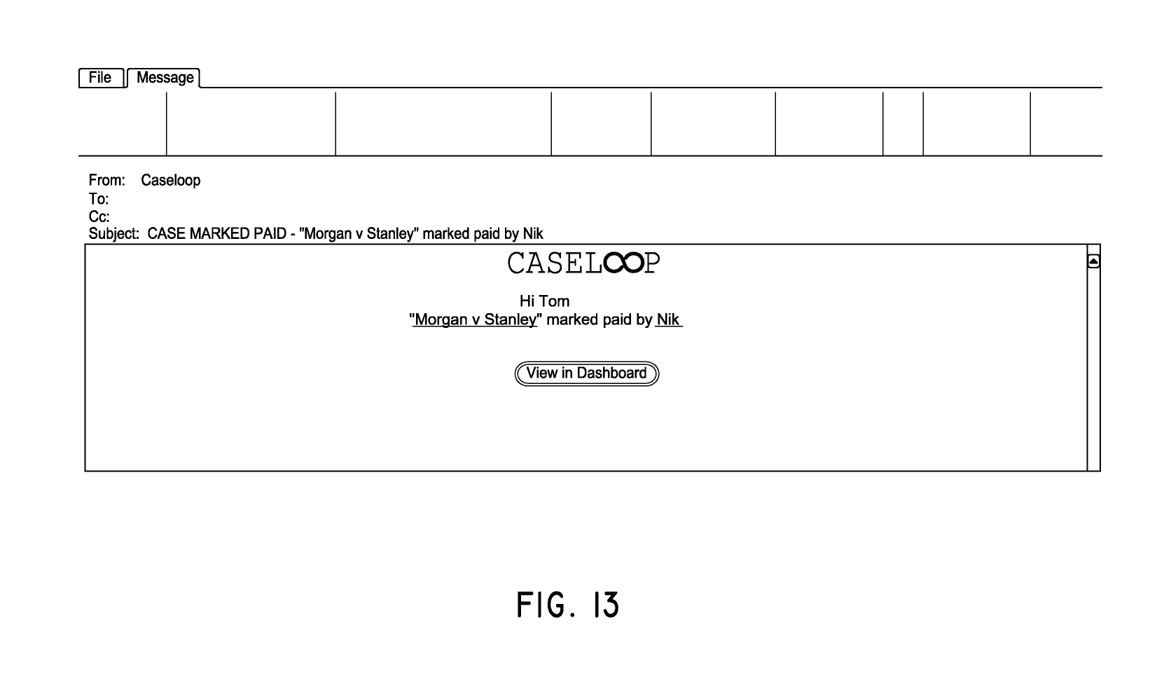

The referral management system 116 can also be used by claims adjusters for tracking case status on matters referred to outside counsel. Medical professionals may also be able to use referral management system 116 to track referrals of their patients. In addition, the referral management system 116 can also be used to manage referrals between an interdisciplinary network of professionals (for example, personal injury attorney referrals to doctors and vice versa, commercial and residential realtors to mortgage brokers and title insurers and vice versa, estate planning attorney referrals to tax advisors and financial planners, etc.). In some embodiments, the referral management system 110 can also be implemented as a mobile application to enable users to manage their referrals on wireless mobile devices (e.g. smart phones, PDAs, tablets, or the like). The mobile application can include push notifications for case and/or connection notifications. Users may also update status of the case via the mobile application as described in one or more embodiments above. For example, users may receive a notification regarding one of their referrals in an email as illustrated in FIG. 13.

### XIII. Terminology

A number of computing systems have been described throughout this disclosure. The descriptions of these systems are not intended to limit the teachings or applicability of this disclosure. For example, the user systems and described herein can generally include any computing device(s), such as desktops, laptops, video game platforms, television set-top boxes, televisions (e.g., internet TVs), computerized appliances, and wireless mobile devices (e.g. smart phones, PDAs, tablets, or the like), to name a few. Further, it is possible for the user systems described herein to be different types of devices, to include different applications, or to otherwise be configured differently. In addition, the user systems described herein can include any type of operating system (“OS”). For example, the mobile computing systems described herein can implement an Android™ OS, a Windows® OS, a Mac® OS, a Linux or Unix-based OS, or the like.

Further, the processing of the various components of the illustrated systems can be distributed across multiple machines, networks, and other computing resources. In addition, two or more components of a system can be combined into fewer components. For example, the various systems illustrated can be distributed across multiple computing systems, or combined into a single computing system. Further, various components of the illustrated systems can be implemented in one or more virtual machines, rather than in dedicated computer hardware systems. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Depending on the embodiment, certain acts, events, or functions of any of the algorithms, methods, or processes described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

Each of the various illustrated systems may be implemented as a computing system that is programmed or configured to perform the various functions described herein. The computing system may include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computing system includes multiple computing devices, these devices may, but need not, be co-located. The results of the disclosed methods and tasks may be persistently stored by transforming physical storage devices, such as solid state memory chips and/or magnetic disks, into a different state. Each process described may be implemented by one or more computing devices, such as one or more physical servers programmed with associated server code.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a” and “an” are to be construed to “mean one or more” or “at least one” unless specified otherwise.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While the above detailed description has shown, described, and pointed out novel features as applied to various embodiments, it will be understood that various omissions, substitutions, and changes in the form and details of the devices or algorithms illustrated can be made without departing from the spirit of the disclosure. Thus, nothing in the foregoing description is intended to imply that any particular feature, characteristic, step, module, or block is necessary or indispensable. As will be recognized, the processes described herein can be embodied within a form that does not provide all of the features and benefits set forth herein, as some features can be used or practiced separately from others. The scope of protection is defined by the appended claims rather than by the foregoing description.

What is claimed is:

1. A computing system comprising:
one or more hardware processors configured to execute a plurality of software modules, the software modules including at least:
a case management module configured to access case data relating to a first attorney, the case data corresponding to one or more cases associated with the first attorney, each case comprising an identifier, a fee value, status information, and one or more attorneys associated with the case; and
a user interface module configured to cause display of a first user interface comprising case data and one or more active links, each one of said active links being associated with a respective one of the one or more cases associated with the first attorney, wherein each of said active links is configured to enable the first attorney to communicate directly with the one or more attorneys associated with the case.

2. The system of claim 1, wherein at least one of the active links comprises a slider configured to enable the first attorney to communicate the status of the case directly with the one or more attorneys.

3. The system of claim 1, wherein at least one of the active links comprises a note input box to enable the first attorney to communicate with the one or more attorneys associated with the case.

4. The system of claim 1, wherein the user interface comprises one or more web pages and/or electronic communications.

5. The system of claim 1, wherein the system is further configured to:
receive updated data corresponding to one or more cases;
store the updated data in one or more data repositories; and
make the updated data available to a second user interface.

6. A method of managing referrals, the method comprising:
storing information corresponding to a case including a list of users associated with the case;
presenting a first user interface including one or more active links;
receiving an update corresponding to the case via the one or more active links; and
making the update available through a second user interface.

7. The method of claim 6, wherein the one or more active links comprise a slider.

8. The method of claim 6, further comprising providing a history of notifications.

9. The method of claim 6, further comprising sending an active notification to a user system.

10. The method of claim 9, wherein sending the active notification comprises sending an email.

11. The method of claim 9, wherein sending the active notification comprises pushing an update via a mobile application.

12. The method of claim 6, further comprising receiving an update via a mobile application.

13. The method of claim 6, wherein making the update available through a second user interface comprises making the update available through a second user interface based on user settings.

14. The method of claim 6, wherein the first and the second user interface comprises one or more web pages and/or electronic communications.

15. A system for providing assistance to a user for managing referrals, the system comprising:
a case management module configured to derive data for a referral associated with a user, the case management module comprising computer hardware configured to:
retrieve information corresponding to plurality of referrals stored in the system, said information comprising final net value for each referral;
generate a statistical analysis on the retrieved information; and
derive a projected net fee for the referral based on the generated analysis.

16. The system of claim 15, further comprising a user interface module configured to display the projected net fee for the referral.

17. The system of claim 16, wherein the case management module notifies a user that it might be a good time to settle the referral.

18. The system of claim 15, wherein the user interface module is further configured to display a chart corresponding to settlement probability based on the generated statistical analysis.

19. The system of claim 16, wherein the user interface module is further configured to provide an active link to contact a suggested attorney for the referral.

20. The system of claim 19, wherein the suggested attorney can be derived based on the generated statistical analysis.
